(19) United States
(12) Patent Application Publication
(10) Pub. No.: US 2014/0298951 A1
(43) Pub. Date: Oct. 9, 2014

(54) Centrifugal machine

(71) Applicant: Richard Foore, Scottdale, PA (US)

(72) Inventor: Richard Foore, Scottdale, PA (US)

(21) Appl. No.: 13/986,179

(22) Filed: Apr. 8, 2013

(51) Int. Cl. H02K 7/02

(52) U.S. Cl. CPC H02K 7/02
USPC 74/572.1

(57) ABSTRACT

Back in the nineteen seventies with the energy crisis. I thought There has to be other sources of energy in the world so I started to experiment with magnets and designed a magnetic generator, but the more I experiment with it I discovered that the earths magnetic field could interfere and also when a magnet gets hot it stopped being a magnet. So as time went on my Attion directed me to gravity. but the energy needed to pick Something up to drop it would be the same.

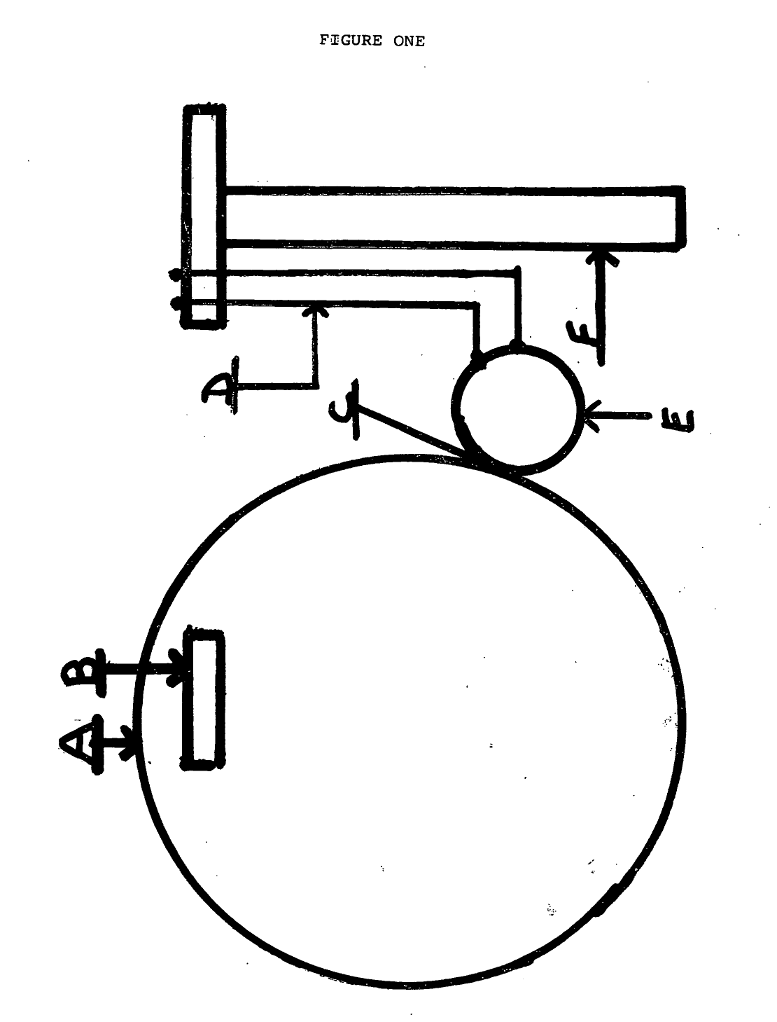

I explored other ways of using gravety it directs me to earth The earth is gravety in motion which is centrifugal force Then all I had to do was desing a device to turn a generator By way of centrifugal force and is what I invented

### SUMMARY OF INVENTION

This invention can be utillized within an electrical grid at a weak point. and to use a percent of electricity at that weak point to establish and keep centrifugal force by a weight affixed to the flywheel so to create centrifugal force and by the flywheel and the generator being applied directly between each other to reduce friction and create a larger ratio that once centrifugal force is established the the generator that is driving that flywheel in time it will switch to the flywheel driving that generator into regenerating electricity back into that weak point to strengthen it

### DESCRIPTION OF FIGURE ONE

A. is the circumference of the fly wheel

B. is a weight affix to the fly wheel to create centrifugal force

C. shows how the fly wheel is applied directly between the fly wheel and the generator.

D. is the point the generator is excepting energy and regenerating it back into the source of electric

E. is a generator, turbine

F. IS A electric pole, the source or grid. once all is in motion the machine will be regenerating energy from centrifugal force. the amount of energy will vary on the size and location of the machine

1. I. clam a new way of regenerating energy with this large Custom made fly wheel design to create centrifugal force too Drive a D.C. turbine into regenerate energy along a electric grid that will strengthen a weak point
